(19) United States
(12) Patent Application Publication
(10) Pub. No.: US 2019/0362367 A1
(43) Pub. Date: Nov. 28, 2019

(54) TECHNIQUES FOR PREDICTION OF LONG-TERM POPULARITY OF DIGITAL MEDIA

(71) Applicant: WP Company LLC, Washington, DC (US)

(72) Inventors: Shuguang Wang, Washington, DC (US); Eui-Hong Han, Washington, DC (US); Dongwon Lee, University Park, PA (US); Yiming Liao, University Park, PA (US)

(73) Assignees: WP Company LLC, Washington, DC (US); The Penn State Research Foundation, University Park, PA (US)

(21) Appl. No.: 16/419,826

(22) Filed: May 22, 2019

Related U.S. Application Data
(60) Provisional application No. 62/675,066, filed on May 22, 2018.

(51) Int. Cl. G06Q 30/02; G06Q 50/00

(52) U.S. Cl. CPC G06Q 30/0201; G06Q 50/01

(57) ABSTRACT

Techniques for the prediction of long-term popularity of digital media are disclosed. In accordance with some embodiments, a digital media prediction system may comprise a memory storing instructions and a processor configured to execute the instructions. The instructions may include obtaining digital media from at least one digital media content source, obtaining user activity data associated with the digital media from at least one client device, and determining at least one characteristic associated with the digital media. The instructions may further include updating a prediction model using the obtained user activity data and the determined at least one characteristic, determining a long-term popularity track by executing the prediction model, comparing the long-term popularity track to a predetermined threshold, and determining that the long-term popularity track exceeds the predetermined threshold. The long-term popularity track may be displayed on a graphical user interface.

### CROSS-REFERENCE TO RELATED APPLICATIONS

This patent application claims priority to U.S. Provisional Patent Application No. 62/675,066, filed on May 22, 2018, the contents of which are incorporated by reference herein in their entirety.

### FIELD OF THE DISCLOSURE

The present disclosure generally relates to data processing and analysis. More specifically, the present disclosure relates to techniques for determining and/or predicting the long-term popularity of digital media using data processing and analysis.

### BACKGROUND OF THE DISCLOSURE

When digital media such as a news article is posted on a website, visitors of the website may read the article or ignore it. Visitors may share the article with friends and/or followers on social media or may not share the article. Indeed, digital media may have varying degrees of popularity, and popularity may be measured in numerous ways. For example, the number of article views and/or the number of article shares on social media may be analyzed. Alternatively, or in addition, the number of article likes on social media and/or the number of article searches in a search engine may be analyzed.

Due to the time sensitive nature of digital media, identifying popular content at early stages is beneficial. For instance, certain content may have longer lifespan compared to other content, and may be referred to “evergreen” content. Because evergreen content maintains popularity over an extended period of time and is reliably of interest to the public, understanding the characteristics of evergreen content may help content producers generate content that gives an audience a better reading experience and attracts more traffic to the content and/or a particular website. Content producers may use evergreen articles to regularly re-promote on social media, update content and statistics when new data is available, and/or serve as context linking URLs and references when editing new articles.

However, predicting the long-term popularity of digital media may be challenging. For example, digital media may be consumed in numerous ways that may not be reflected in the common metrics for popularity. Conventional prediction models may struggle with processing and analyzing the complex and large amounts of data related to these aspects and may therefore generate inaccurate predictions. Additionally, content can be defined in different contexts, such as local or global. Local context may relate to digital media within a local environment, such as the popularity of a news article by single news agency relative to other articles published by that news agency (e.g., the popularity of a Washington Post article relative to other Washington Post articles). Global context may relate to ascertaining popularity of a news article published by a first news agency relative to other articles published by other news agencies. Conventional prediction models may struggle to accurately predict popularity in both local and global contexts.

Moreover, conventional models may require a significant amount of time to determine digital media popularity with requisite accuracy. After such time passes, the digital media may no longer be relevant, and opportunities for taking actions based on the media popularity may have passed. For example, journalists and editors may miss opportunities to refine popular articles, and/or advertisers may miss potentially beneficial advertising space within popular articles. Particularly for evergreen articles that exhibit long-term popularity, conventional models may be unable to identify evergreen articles at an early stage, before sufficient time has passed to collect and analyze a large dataset of the long-term interactions with the content. For instance, the short-term popularity of content may not reflect its long-term popularity. The temporal popularity of “viral” content may dissipate quickly as the audience's attention moves on to the next viral digital media. Early identification of evergreen articles can therefore be difficult due to the early popularity of viral articles.

Therefore, a need may exist for systems and methods that predict the long-term popularity of digital media and overcome shortcomings associated with conventional processes.

### SUMMARY OF THE DISCLOSURE

In some embodiments, digital media prediction system may comprise a memory storing instructions and a processor configured to execute the instructions. The instructions may include obtaining digital media from at least one digital media content source, obtaining user activity data associated with the digital media from at least one client device, and determining at least one characteristic associated with the digital media. The instruction may include updating a prediction model using the obtained user activity data and the determined at least one characteristic, determining a long-term popularity track by executing the prediction model, comparing the long-term popularity track to a predetermined threshold, and determining that the long-term popularity track exceeds the predetermined threshold. The long-term popularity track may be displayed on a graphical user interface.

In some embodiments, the digital media may be a digital article posted on a webpage.

In some embodiments, the digital media prediction system of claim 1, wherein the user activity comprises the number of views of the digital media.

In some embodiments, the user activity may comprise the number of shares of the digital media with other users of a social media platform.

In some embodiments, the user activity may be obtained in real-time from the at least one client device.

In some embodiments, the user activity may be archived activity that originated from the at least one client device.

In some embodiments, the at least one characteristic may be a topic of the digital media.

In some embodiments, the predetermined threshold may define a minimum number of digital media views.

In some embodiments, the prediction model may be formed by

$$\frac{1}{n} {\sum }_{i = 1}^{n} \geq α and \frac{1}{n * {\sum }_{i = 1}^{n} } {{\sum }^{n}}_{i = 1} {\sum }_{j = 1}^{i} \leq β ,$$

wherein α defines a minimum guaranteed monthly views of the digital content, β controls a decreasing rate of the digital media views, γ defines a window size, and wherein a first time series associated with the digital media may be PV=(pv₁, pv₂, . . . , pvₙ), and a smoothed first time series associated with the digital media may be [symbol] =( [symbol] , [symbol] , . . . , [symbol] ).

In some embodiments, γ may be equal to 5.

In some embodiments,

$$= median ( [ {pv}_{i - \frac{γ}{2}} , . . . , {pv}_{i + \frac{γ}{2}} ] )$$

In some embodiments, a method of predicting digital media popularity comprises obtaining digital media from at least one digital media content source and analyzing the digital media using a prediction model, wherein the prediction model may be formed by

$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β ,$$

wherein α defines a minimum guaranteed monthly views of the digital content, β controls a decreasing rate of the digital media views, γ defines a window size, and wherein a first time series associated with the digital media may be PV=(pv₁, pv₂, . . . , pvₙ), and a smoothed first time series associated with the digital media may be [symbol] =( [symbol] , [symbol] , . . . , [symbol] ). The method may include determining a long-term popularity track using the analysis of the digital media and displaying the long-term popularity track on a graphical user interface.

In some embodiments, the digital media may be a digital article posted on a webpage.

In some embodiments, the method may further comprise comparing the long-term popularity track to a predetermined threshold, and determining that the long-term popularity track exceeds the predetermined threshold.

In some embodiments, γ may be equal to 5.

In some embodiments,

$$= median ( [ {pv}_{i - \frac{γ}{2}} , … , {pv}_{i + \frac{γ}{2}} ] )$$

In some embodiments, A digital media prediction system may comprise a memory storing instructions and a processor configured to execute the instructions. The instructions may include obtaining digital media from at least one digital media content source and analyzing the digital media using a prediction model, wherein the prediction model may be formed by

$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β ,$$

wherein α defines a minimum guaranteed monthly views of the digital content, β controls a decreasing rate of the digital media views, γ defines a window size, and wherein a first time series associated with the digital media may be PV=(pv₁, pv₂, . . . , pvₙ), and a smoothed first time series associated with the digital media may be [symbol] =( [symbol] , [symbol] , . . . , [symbol] ). The instructions may include determining a long-term popularity track using the analysis of the digital media and displaying the long-term popularity track on a graphical user interface.

In some embodiments, the digital media may be a digital article posted on a webpage.

In some embodiments, the instructions may further comprise comparing the long-term popularity track to a predetermined threshold and determining that the long-term popularity track exceeds the predetermined threshold.

In some embodiments, γ may be equal to 5.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a system in accordance with embodiments of the present disclosure.

FIG. 2 shows a flow chart of a process for determining long-term popularity of digital media in accordance with embodiments of the present disclosure.

FIGS. 3(a)-(c) show diagrams reflecting two exemplary pieces of digital media with similar initial traffic data showing different long-term popularity patterns.

FIG. 4 shows a plot of median views of digital media as a function of time in accordance with embodiments of the present disclosure.

FIG. 5 shows a plot of the median filtered traffic pattern of the two exemplary pieces of digital media in FIG. 3.

FIGS. 6(a)-(b) show diagrams of multiple median filtering window models in accordance with embodiments of the present disclosure.

FIG. 7 shows a plot comparing the median page views between evergreen and trending digital media in accordance with embodiments of the present disclosure.

FIG. 8 shows a table showing the top 10 categories for evergreen digital media in accordance with embodiments of the present disclosure.

FIG. 9 shows a plot comparing the monthly median page views of selected categories in accordance with embodiments of the present disclosure.

FIG. 10 shows a table showing the top ranked topics for evergreen digital media in accordance with embodiments of the present disclosure.

FIGS. 11(a)-(b) show plots of the fraction of digital media published in each hour of the day and on each day of the week in accordance with embodiments of the present disclosure.

FIGS. 12(a)-(d) show multiple plots comparing the compound sentiment scores of both the body and title of digital media in accordance with embodiments of the present disclosure.

FIG. 13 shows a table comparing the features vectors in various categories in accordance with embodiments of the present disclosure.

FIG. 14 shows a table showing the results of different feature combinations cross-validation conducted on the same 10 folds in accordance with embodiments of the present disclosure.

FIG. 15 shows a plot of the page view patterns of top predicted evergreen digital media under different feature groups in accordance with embodiments of the present disclosure.

FIG. 16 shows a plot of the page view patterns comparison between top predicted evergreen digital media and top trending digital media in accordance with embodiments of the present disclosure.

### DETAILED DESCRIPTION OF EMBODIMENTS

In the following description, numerous specific details are set forth regarding the systems and methods of the disclosed subject matter and the environment in which such systems and methods may operate in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

Embodiments of the present disclosure provide for a system, method, non-transitory computer readable medium storing instructions thereon for executing a method or software instructions, for determining and/or predicting the long-term popularity of digital media.

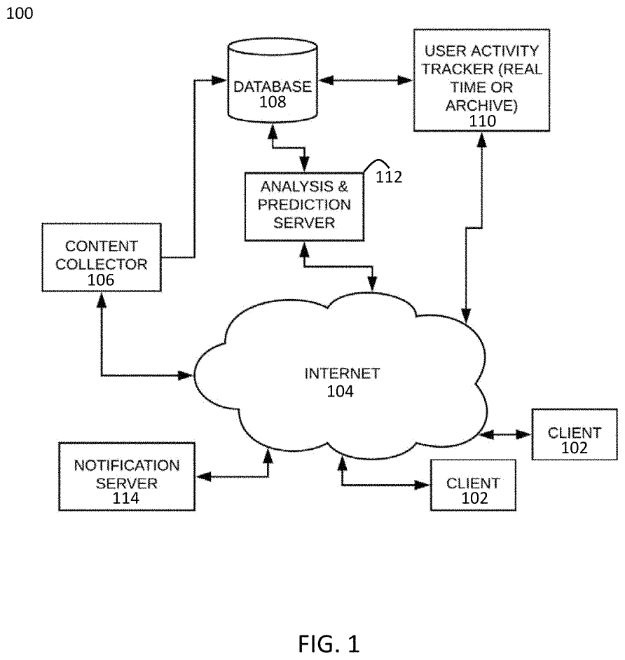

FIG. 1 shows a system 100 in accordance with embodiments of the present disclosure. One or more of the elements 102-114 of System 100 may be implemented in a single computing device, or may be implemented in multiple computing devices. Exemplary computing devices include servers, personal computers, laptop computers, mobile computers, and the like that may include one or more processors and/or one or more memories. The one or more memories may store instructions for processes in accordance with embodiments of the present disclosure, and those instructions may be executed by the one or more processors.

System 100 may include one or more client devices 102. While two client devices are shown in system 100, only one or alternatively, two or more client devices 102 may be present in system 100. Client device 102 may be a computing device such as personal computer, laptop computer, cellular phone, tablet computer, and the like, that access digital media. Client device 102 may access digital media via one or more web browsers. The one or more web browsers may be standalone applications that are present on client device 102, or may be platforms that are present within social media applications such as FacebookTM or TwitterTM accessed on client device 102, for example.

System 100 may also include internet 104. Internet 104 may facilitate the transmission and reception of data between different elements that are connected to it. Internet 104 may use one or more of broadband, dial-up, Wi-Fi, satellite, and cellular (e.g., 3G, 4G, 5G, etc.) technology, for example.

System 100 may include content collector 106. Content collector 106 may be a computing device such as a server, personal computer, laptop computer, mobile computer, and the like that may include one or more processors and/or one or more memories. Content collector 106 may obtain digital media from one or more sources via internet 104. For example, content collector 106 may obtain digital media such as an article posted to a webpage. For example, content collector 106 may obtain digital media such as a news article posted to a webpage and/or shared on a social media platform.

System 100 may include a database 108. Database 108 may be a computing device such as a server, personal computer, laptop computer, mobile computer, and the like that may include one or more processors and/or one or more memories. Database 108 may store one or more of the digital media obtained by content collector 106. For example, database 108 may store one or more articles posted to a webpage or social media platform that was obtained by content collector 106.

System 100 may include an activity tracker 110. Activity tracker 110 may be a computing device such as a server, personal computer, laptop computer, mobile computer, and the like that may include one or more processors and/or one or more memories. Activity tracker 110 may track activity associated with digital media viewed by one or more client devices 102. For example, activity tracker 110 may track the number of views, clicks, or other interactions with digital media performed by a client device 102. Activity tracker 110 may track the number of shares of digital media by a client device 102. Activity tracker 110 may track indicators associated with digital media, such as “likes,” emoticons associated with the article, or other indicators used to interact with digital media by a user of a client device 102. Activity tracker 110 may track real time activity of client devices 102 that is associated with digital media or use archived activity of client devices 102 associated with digital media that is stored in database 108. Activity tracker 110 may provide activity information associated with digital media to analysis and prediction server 112. The activity information may be provided to analysis and prediction server 112 via internet 104 or via communication with database 108. Analysis and prediction server 112 may thereafter perform its data processing to determine features that help predict long-term popularity of digital media.

System 100 may include an analysis and prediction server 112. Analysis and prediction server 112 may be a computing device such as a server, personal computer, laptop computer, mobile computer, and the like that may include one or more processors and/or one or more memories. Analysis and prediction server 112 may analyze digital media stored in database 108. For example, digital media may be collected by content collector 106 and stored in database 108, and analysis and prediction server 112 may process such digital media to analyze it. The analyzing may include, for example, determining one or more features associated with the digital media. The one or more features may include, for example, traffic data, metadata, contextual or content-based data, temporal features, and social features.

Traffic data may, for example, reflect how many views or interactions a particular piece of digital content has. For example, traffic data may reflect the number of times a particular article on a webpage has been viewed. Metadata may, for example, include data that reflects characteristics of digital media, such as when it was uploaded to a webpage or social media or when it was last edited. For example, metadata may reflect when an article was last updated to include additional information about a story. Contextual or context-based data may include, for example, a category and/or a topic associated with digital media. For example, a category of the content, could be politics, opinions, and business. For example, certain categories of content may generate more popularity than others. For example, a topic may be housing, health, education, and research studies. For example, digital media containing certain words or pertaining to certain topics may be more likely to exhibit long-term popularity. Temporal features may include, for example, the total amount of time that digital media has been posted to a particular website, or a subset of the total amount of time that digital media has been posted to a particular website. Alternatively, or in addition, temporal features may include publication time of the digital media. For example, trending digital media that is popular in the short-term may be published at any time of the day. This is because, for example, trending digital media may be breaking news that can occur at any time. It may be more likely that digital media exhibiting long-term popularity be published during the day (for example, between 9:00 AM and 5:00 PM) as the product of planned or scheduled release, rather than the product of a noteworthy event or occurrence. Social features may include, for example, interactions with digital media. For example, social features may include the number of “likes” or “shares” associated with digital media, and/or the number and type of emoticons associated with the article, or other indicators used to interact with digital media. Alternatively, or in addition, the features may include author of digital media and publishing history associated with the author. For example, authors that write many articles in diverse categories may be more likely to generate digital content having extended popularity. One example is an investigative journalist who writes articles in different categories or on different topics, but with an emphasis on research and labor-intensive evidence gathering. Thus, the author and their publishing historγ may be included in the prediction.

Analysis and prediction server 112 may compile the determined plurality of features in real time along with activity associated with the features. For example, the analysis and prediction server 112 may determine the activity associated with the traffic data and social features. The activity may be, for example, the number of views or interactions a particular piece of digital content has, interactions with digital media, the number of “likes” or “shares” associated with digital media, and/or the number and type of emoticons associated with the article, or other indicators used to interact with digital media.

Analysis and prediction server 112 may predict a popularity associated with the digital media using the compiled plurality of features and activity. The prediction may be performed using one or more prediction models, for example. A prediction model may use initial values, but may be updated after analysis and/or prediction associated with digital media has been performed. The one or more prediction models may include one or more regression models and/or one or more classification models. The one or more models may be evaluated for popularity prediction, and the one or more determined best performing models may be applied in a real-time system to real time data or on archived data.

For example, Analysis and prediction server 112 may collect one or more of the traffic data, metadata, contextual or content-based data, temporal features, and social features associated with the digital media. Analysis and prediction server 112 may determine which one or more of these features should be used in forming a prediction. Analysis and prediction server 112 may then analyze the digital media using one or more of the content, traffic data, metadata, contextual or content-based data, temporal features, or social features. Alternatively, or in addition, Analysis and prediction server 112 may also collect associated activity data. The activity data may include the numerical data amount associated with one or more of the features. For example, the activity data may include the number of digital media views, number of likes or shares on Facebook™ or another social media site such as Twitter™, and/or the number of searches associated with the digital media in an online or electronic search engine.

Analysis and prediction server 112 may form a prediction of popularity associated with the digital media using a prediction model and the collected one or more of the traffic data, metadata, contextual or content-based data, temporal features, and social features associated with the digital media. Alternatively, or in addition, Analysis and prediction server 112 may also use the collected activity data in forming the prediction. Analysis and prediction server 112 may remove one or more features from consideration for prediction, and/or may adjust activity associated with features to remove outliers and provide that more reliable information is used to form the prediction.

Alternatively, or in addition, analysis and prediction server 112 may use click-stream and/or content of the digital media, features estimating the freshness of digital media, and/or sentiment features that indicate reader's attitude to digital media in the prediction. Sentiment may reflect whether the digital content has a positive or negative reaction among readers. Sentiment for digital media can be evaluated by, for example, examining the sentiment of the media title and/or content. For example, non-opinion articles might carry a more neutral sentiment, whereas opinion articles and editorials could be more polarizing (for example, very negative or very positive). The opinion article may exhibit better long-term popularity because of its polarizing position and use as a reference by readers for that position. Sentiment may be determined by analyzing words that are used in the digital media as well as the count of such words, for example.

Analysis and prediction server 112 determine that the predicted popularity satisfies a predetermined definition. For example, the prediction may meet or exceed a popularity threshold that indicates predicted digital media views, interactions, shares, likes, and/or types of emoticons, for example. For example, the prediction may meet or exceed a popularity threshold that indicates whether digital media will be considered evergreen content exhibiting long-term popularity. Analysis and prediction server 112 may update the prediction model as more predictions occur and/or as one or more of additional digital media, features, and activity is analyzed.

Analysis and prediction server 112 may notify a client 102 if the threshold is met or exceeded. Alternatively, or in addition, analysis and prediction server 112 may notify a client 102 if the threshold is not met or exceeded. Analysis and prediction server 112 may instead signal to notification server 114 if the threshold is met or exceeded and/or may signal to notification server 114 if the threshold is not met or exceeded. Notification server 114 may notify a client 102 of whether the threshold was met, exceeded, not met, or not exceeded.

Analysis and prediction server 112 may determine whether a prediction should be performed in one or both of a local and/or global context, and may perform prediction in one or both of these contexts. For example, local context measures may help ascertain the popularity of digital media within a single content source, such as a single news or media agency. For example, global context measures may help ascertain the popularity of online content amongst media items and articles from other content sources, such as other news or media agencies.

The one or more prediction models of the present disclosure may be used as follows. A time segment page view time series for digital media PV=(pv₁, pv₂, . . . , pvₙ) may be defined.

A median filter with window size γ may be used to smooth the time series as [symbol] =( [symbol] , [symbol] , . . . , [symbol] ). For example, for

$$, = median ( [ {pv}_{i - \frac{γ}{2}} , … , {pv}_{i + \frac{γ}{2}} ] ) .$$

### Thus, for

example,

$$= median ( [ {pv}_{1 - \frac{γ}{2}} , … , {pv}_{1 + \frac{γ}{2}} ] ) .$$

For example, evergreen digital media exhibiting long-term popularity may have a smoothed time series [symbol] satisfying an average time segment view as

$$\frac{1}{n} {\sum }_{i = 1}^{n} \geq α ,$$

and the area under normalized accumulated view as

$$\frac{1}{n * {\sum }_{i = 1}^{n} } {\sum }_{i = 1}^{n} {\sum }_{j = 1}^{i} \leq β .$$

Parameters α, β, and γ may be adjusted, wherein α may define the minimum guaranteed time segment views, β may control the decreasing rate of the media's views, and γ may define the window size used to smooth sudden media view peaks caused by unpredictable events. In some embodiments, the window size γ may be set to 5. For example, parameter n may be the total number of time segment traffic data to be considered for each digital media. For example, i and j stand for i-th and j-th time segment. The time segment may be a certain amount of time, such a month or a day. For example, if each digital media's first 2-year traffic data, when the time segment reflects a month, n may be 24 as there are 24 months in 2 years, and i and j may reflect a particular month.

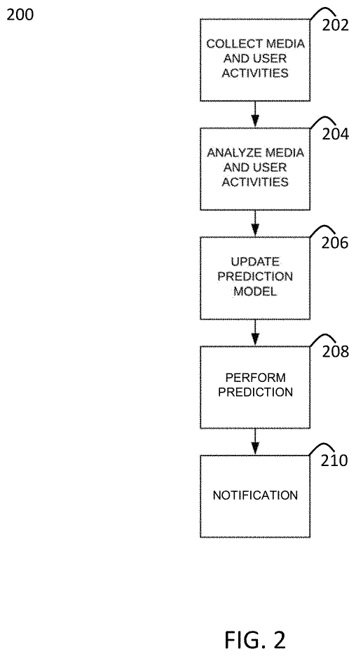

FIG. 2 shows a flow chart of a process 200 for determining long-term popularity of digital media in accordance with embodiments of the present disclosure. It should be noted that not all of the steps listed in process 200 may be included in process 200, and that one or more of the steps may be skipped.

Process 200 may include collecting media and user activities in step 202. For example, in step 202, digital media and user activities may be collected for analysis. For example, digital media may be collected by content collector 106. The digital media may be content posted on a webpage or present in an application, for example. The collected digital media may include one or multiple pieces of content, for example. User activity may also be collected in step 202. For example, activity tracker 110 may track and collect the number of views, clicks, shares with other users of a social media platform, or other interactions performed by one or more client devices 102 that are associated with the collected digital media. Activity tracker 110 may track and collect indicators associated with digital media that is collected, such as “likes,” emoticons associated with the article, or other indicators used to interact with digital media by a user of a client device 102. Activity tracker 110 may track and collect real time activity of client devices 102 that is associated with collected digital media or use archived activity associated with collected digital media that originated from client devices 102. The collected media and user activities may be compiled in database 108, for example.

Process 200 may include analyzing the media and user activities in step 204. For example, analysis and prediction server 112 may access the collected digital media and/or user activities compiled in database 108. Analysis and prediction server 112 may perform analysis that determines characteristics of digital media such as a category or topic it relates to, when it was published on a particular webpage or application platform, and amount of time that the digital media has been published. Analysis and prediction server 112 may analyze the collected user activities to determine the number of views, clicks, shares, or other interactions performed by one or more client devices 102 that are associated with the collected digital media. Analysis and prediction server 112 may also analyze the collected indicators associated with digital media that is collected, such as “likes,” emoticons associated with the article, or other indicators used to interact with digital media to determine how digital media has been interacted with.

Process 200 may include updating a prediction model in step 206. For example, one or more prediction models may be updated. For example, the prediction model defined by

$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β$$

may be updated such that its parameters α, β, and γ may be adjusted to different values from their initial values due to the collected digital media and/or collected user activities. For instance, initially, one or more of α, β, and γ may be set to values that are based on an initial training set of digital media. Application of the model to a second set of digital media, such as the collected (or archived) set of digital media may be analyzed and it may be determined that one or more of α, β, and γ require updating to accurately predict evergreen media from the second set. Thus, one or more regression models and/or classification models may be weighted according to analysis of the second set and executed to determine one or more updated α, β, and γ parameters. The updated one or more α, β, and γ parameters may then be used to determine evergreen digital media in the collected (or archived) set of digital media using

$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β .$$

Process 200 may include performing prediction in step 208. For example, one or more prediction models may be executed to determine one or more long-term popularity tracks associated with the collected digital media. Prediction may be performed for one or more pieces of content within the digital media. For example, prediction may be performed on one or more webpage articles within the digital media to determine long-term popularity of the one or more webpage articles. A predetermined threshold of popularity may be selected, for example. The threshold may define, for example, a threshold number of page views or a threshold logarithmic page view value. The threshold may be set to compare how a track performs over a particular time period. For instance, the threshold may define the minimum number of page views to which a track is consistently compared to. The threshold may be adjusted such that it is increased or decreased, for example. If the determined long-term popularity track is equal to or greater than the threshold, the content may be determined as “evergreen” or having a long-term popularity that indicates users or readers of the digital content will have an extended interest in the content. Thus, the content may be published for a longer time period compared to other pieces of content that have lower long-term popularity. Alternatively, or in addition, content providers may thereby have an indication of content that users and webpage viewers are most interested in, and may produce more content related to similar topics and/or categories as the digital content having an increased long-term popularity. Alternatively, or in addition, advertisers may be more inclined to pay higher prices and/or include more advertising on webpages of digital content having increased long-term popularity since this content may have increased visitor traffic relative to other digital content. If the determined long-term popularity track is less than the threshold, the content may be determined as not having a long-term popularity that indicates users or readers of the content will have an extended interest in the content. This information may be valuable because it may help content providers determine topics and/or categories that are not of as high interest among readers, and in turn, which topics and/or categories content providers should focus on for producing digital content. Moreover, advertising decisions may be made based on this information, where lower advertising prices may be provided for such content because deceased visitor traffic is present relative

Process 200 may include notification in step 210. For example, one or more client devices 102 may be notified by analysis and prediction server 112 when a long-term popularity prediction is determined to be equal to or greater than the threshold, or lower than the threshold. The notification may be a data transmission, for example, that occurs via internet 104. The one or more client devices 102 may display the long-term popularity prediction track on a graphical user interface. Alternatively, or in addition, the long-term popularity prediction track may be displayed on a graphical user interface of any of the other elements shown in system 100.

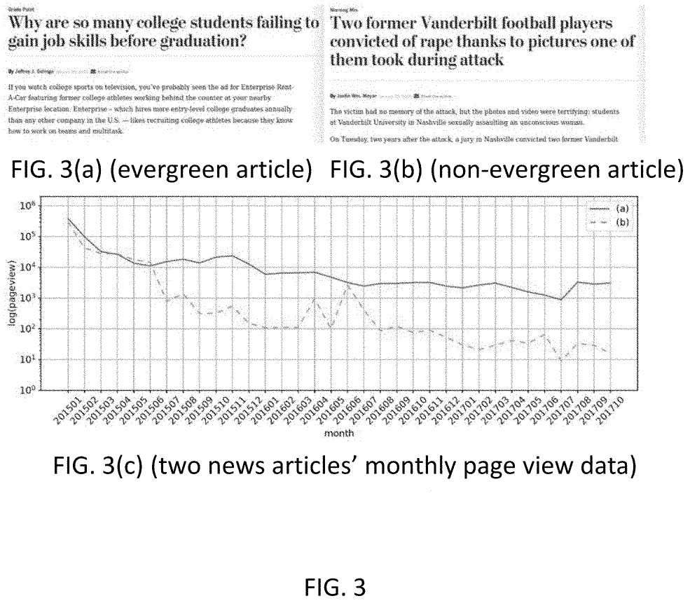

FIGS. 3(a)-(c) show diagrams reflecting two exemplary pieces of digital media with similar initial traffic data showing different long-term popularity patterns. FIG. 3a shows a first exemplary article that is considered an evergreen or having increased long-term popularity. FIG. 3b shows a second exemplary article that is not considered evergreen and has a lower long-term popularity compared to the article of FIG. 3a. FIG. 3c shows a comparison of the first article (a) and the second article (b). As shown by FIG. 3c, despite attracting similar page views in the first few months, these two articles exhibit radically different traffic patterns in long-term. The first article (a) maintains high traffic long after publication and achieves more than 5,000 page views one year later, while the traffic of second article (b) drops dramatically and down to around 100 after one year. Article (a) is more consistently of interest to the readers and sharing such articles is more valuable. Thus, article (a) is an evergreen article.

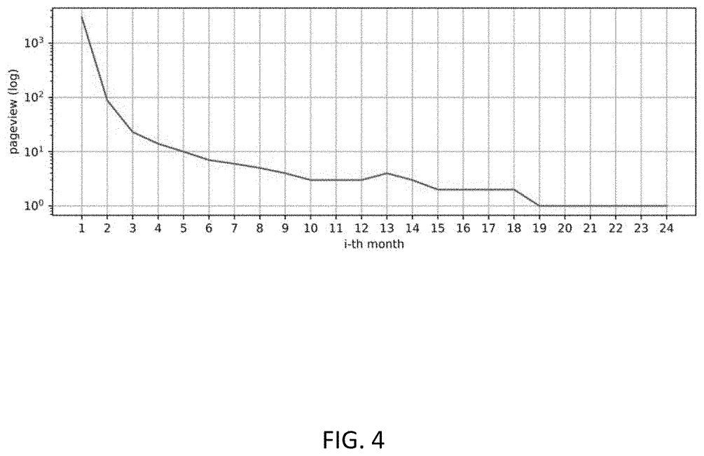

FIG. 4 shows a plot of median views of digital media as a function of time in accordance with embodiments of the present disclosure. For example, FIG. 4 shows exemplary page views for digital media may start high once digital media is first published, but may decline to lower values as time increases away from initial publication time.

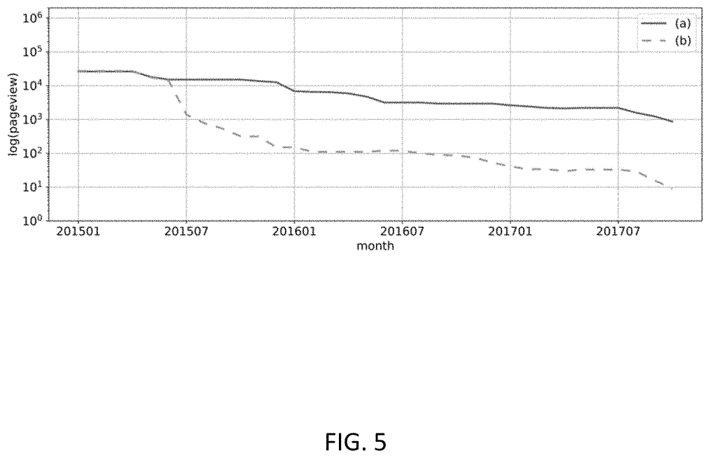

FIG. 5 shows a plot of the median filtered traffic pattern of the two exemplary pieces of digital media in FIG. 3. Smoothing filtering was applied to the data to remove sudden traffic peaks due to unpredictable events and thereby obtain a more accurate representation of long-term popularity for articles (a) and (b).

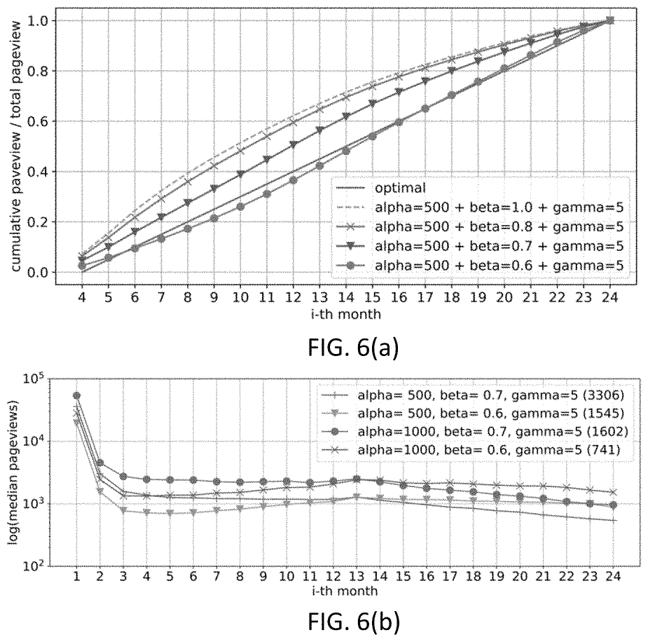

FIGS. 6(a)-(b) show diagrams of multiple median filtering window models in accordance with embodiments of the present disclosure. Here, the prediction model defined by

$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β$$

produces various predicted page view versus month tracks, where the values of α, β, and γ are adjusted. As shown by FIG. 6(a), a may be set to 500. β may be set to 0.6, 0.7, 0.8, or 1.0. γ may be set to 5. As shown in FIG. 6(b), α may be set to 500 or 1000. β may be set to 0.6 or 0.7. γ may be set to 5. It should be noted that these values in FIGS. 6(a) and 6(b) are exemplary, and other values may be used for α, β, and γ. FIGS. 6(a) and 6(b) show that decreasing β may help filter out digital media having faster declining patterns in page views.

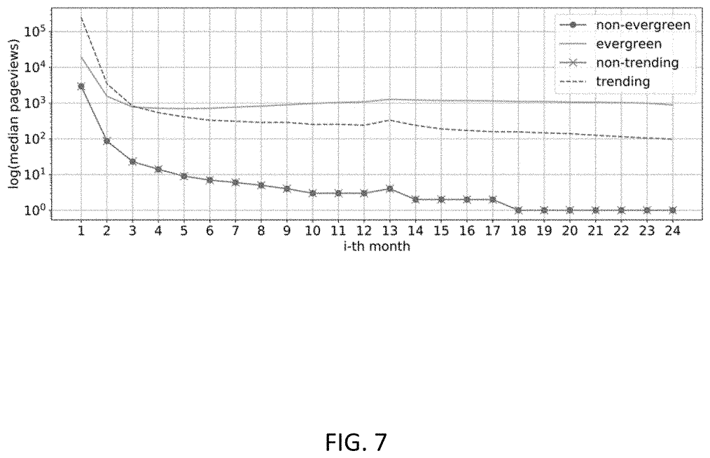

FIG. 7 shows a plot comparing the median page views between evergreen and trending digital media in accordance with embodiments of the present disclosure. As shown by FIG. 7, trending digital content has higher initial traffic compared to evergreen, non-trending, and non-evergreen content, but trending content exhibits lower long-term traffic compared to evergreen content. Indeed, evergreen content generally has almost an order of magnitude higher monthly page views after one year of publication.

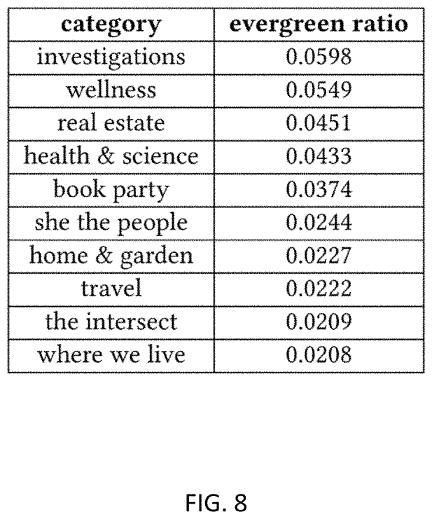

FIG. 8 shows a table showing the top 10 categories for evergreen digital media in accordance with embodiments of the present disclosure. For example, digital media may be assigned a category such as politics, opinions and business. Categories may play an important role in identifying trending content, where some categories tend to generate more viral content than others. In FIG. 8, excluding categories with less than 100 articles, categories of digital media were sorted into remaining 128 categories by their evergreen ratio and the top 10 are listed. In particular, the evergreen ratio reflects the number of evergreen articles in a category compared to all articles of the category. As demonstrated in FIG. 8, investigations, wellness, real estate, and health and science related topics convey higher percentage of evergreen content.

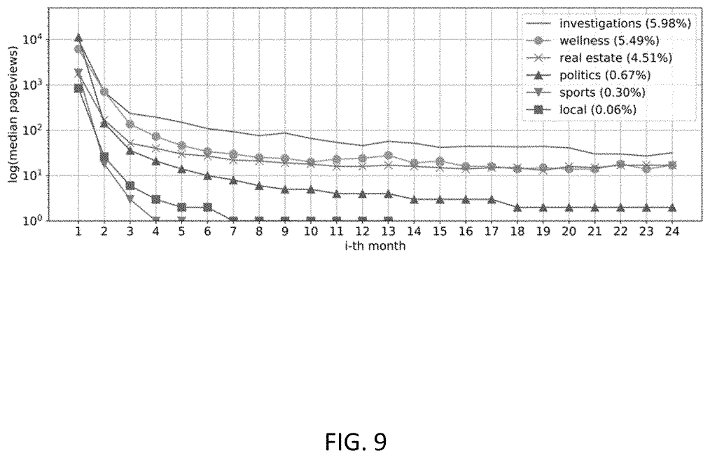

FIG. 9 shows a plot comparing the monthly median page views of selected categories in accordance with embodiments of the present disclosure. As expected, categories with higher evergreen ratios tended to attract more traffic in the long-term, which validates the impact of media categories on their long-term popularity.

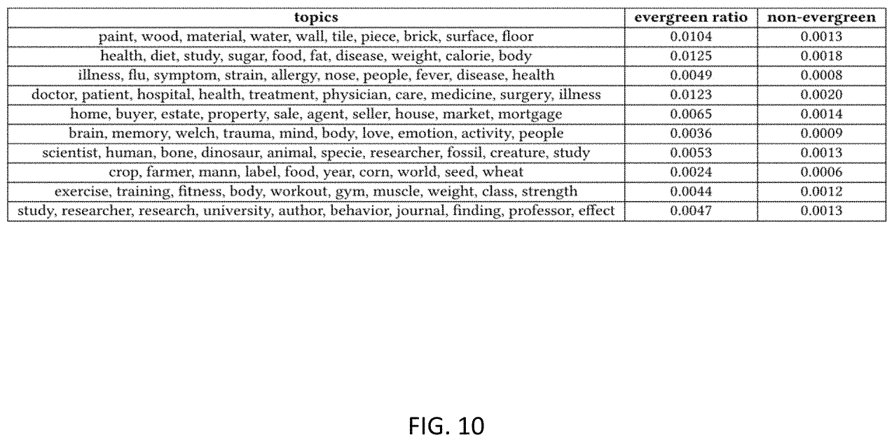

FIG. 10 shows a table showing the top ranked topics for evergreen digital media in accordance with embodiments of the present disclosure. For example, a 1000-topic noun only topic model with LightLDA may be trained and applied to compare topic distributions between evergreen articles with non-evergreen articles. Sorted by the ratio of each topic's proportion in evergreen articles to its in non-evergreen articles, the top ranked evergreen topics are shown in FIG. 10. As shown by FIG. 10, topics relating to housing and health have the highest evergreen ratio.

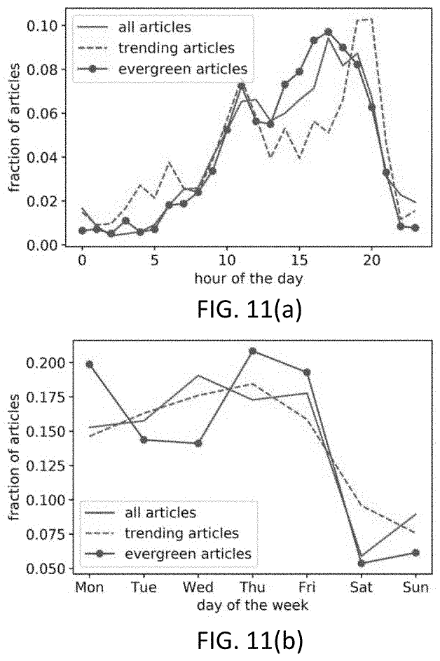

FIGS. 11(a)-(b) show plots of the fraction of digital media published in each hour of the day and on each day of the week in accordance with embodiments of the present disclosure. Trending articles may be more evenly distributed in different publication slots than evergreen articles. To quantize the variation, coefficient of variance for each article groups may be calculated and trending articles may carry the lower coefficient of variance, 0.627 in hour of the day and 0.268 in day of the week, while evergreen articles have the higher scores, 0.774 in hour of the day and 0.414 in day of the week. This phenomenon may result from the fact that trending news (or breaking news) can happen at any time of the day, whereas evergreen articles are mainly published at working time with other normal articles.

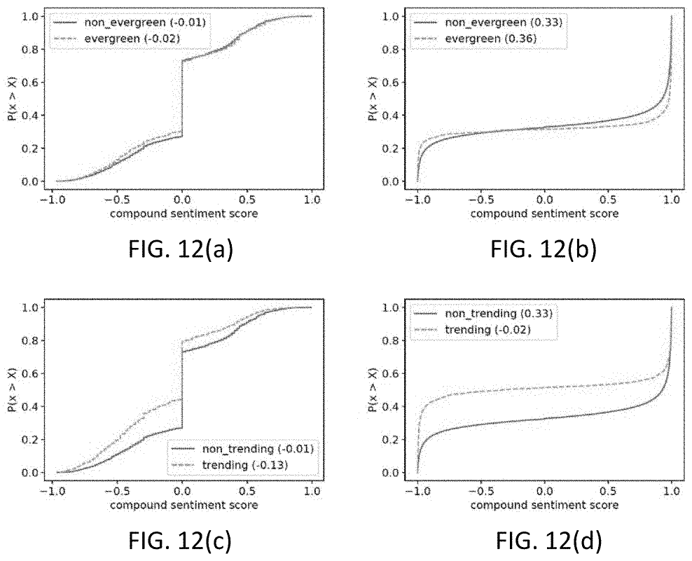

FIGS. 12(a)-(d) show multiple plots comparing the compound sentiment scores of both the body and title of digital media in accordance with embodiments of the present disclosure. Vader sentiment analyzer to examine articles' sentiment and present cumulative distribution function of the compound sentiment scores of both full content and title in FIG. 10. Compound sentiment scores range from −1 to +1, indicating most extreme negative to most extreme positive. FIGS. 12(a)-(d) show that most digital media under analysis carried neutral titles and positive contents, while evergreen media showed more clear polarity in whether it was positive or negative.

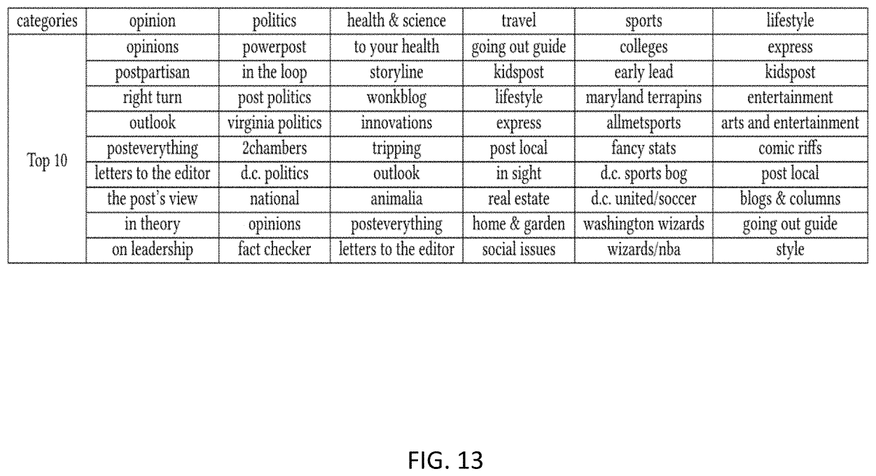

FIG. 13 shows a table comparing the features vectors in various categories in accordance with embodiments of the present disclosure. For instance, within each category, a category feature space is listed that ranks in the top 10 of producing the most evergreen content relative to all content in a particular category.

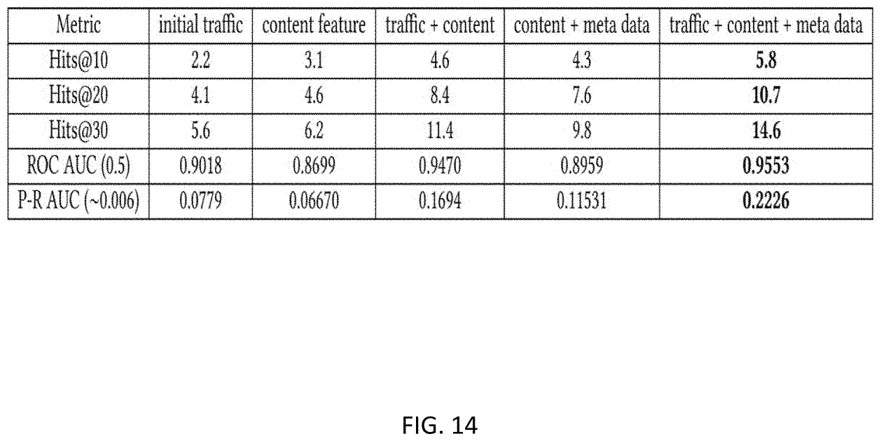

FIG. 14 shows a table showing the results of different feature combinations cross-validation conducted on the same 10 folds in accordance with embodiments of the present disclosure. For example, more than 100 features may be extracted for digital media. In an embodiment, these features may be organized into sets and evaluated for their incremental improvement. In an embodiment, all experiments may be conducted using 10-fold cross validations. Because relatively few items and articles may exhibit long-term popularity behavior, the dataset may be highly imbalanced. The Area Under Receiver Operating Characteristic Curve (ROC AUC) and Area Under Precision Recall Curve (P-R AUC) may be used to report the performance. In an embodiment, the performance of the regression and other models on evergreen articles is determined.

For example, the prediction model discussed previously may have α=500, β=0.6, and γ=5. Using the model, 1,545 articles out of the total 253,043 news articles may be marked as evergreen news articles, resulting in a rare class classification problem in that only 0.6% news articles are identified having long-term popularity. Because of the imbalanced dataset, models may be compared with both Area Under Receiver Operating Characteristic Curve (ROC AUC) and Area Under Precision Recall Curve (P-R AUC), where random baselines are 0.5 and 0.006 respectively. Moreover, Hits@K is also provided to show the performance of top K number of predictions. Since there are around 150 articles out of about 25,000 are labeled as evergreen in each fold, Hits@K is expected to be K when K ranges from 10 to 30. The results of different feature combinations are conducted on the same 10 folds and given in FIG. 14.

Adding content and meta features gives a significant improvement on all metrics in FIG. 14. When utilizing all the features, the best performance may be achieved when traffic, content, and meta data is used as the P-R AUC improves from 0.0779 to 0.2226 and Hits@30 increases from 5.6 to 14.6. Prepublication prediction, which only considers content and meta features, achieves very promising results, where about ⅓ of the articles in the top 30 predictions out of about 25,000 articles are confirmed among the about 150 evergreen news articles. Moreover, when adding traffic features, improvements in P-R AUC and Hits@K are almost linear, indicating that news article's initial traffics and contents may contribute to its long-term popularity in different aspects and both of them may be important in early prediction. Embodiments of the present disclosure provide for traffic evaluation that examines temporal page view patterns of identified evergreen online content. For example, the traffic evaluation may use the best setting from a 10-fold cross validation to train a model a historical dataset to predict evergreen online news articles. By comparing different feature groups, the traffic patterns can predict evergreen articles with different feature groups. More specifically, for each model, news articles may be ranked by the predicted probabilities among their publication month, and top 100 ranked articles in each month chosen as potential evergreen articles. Additionally, although articles predicted with traffic feature show dramatically higher initial traffic, in some cases they may display similar page view trajectories with articles predicted with prepublication features long after publication.

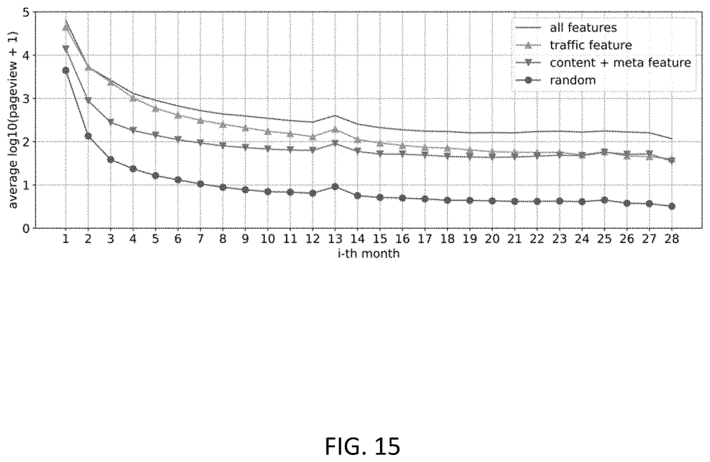

FIG. 15 shows a plot of the page view patterns of top predicted evergreen digital media under different feature groups in accordance with embodiments of the present disclosure. Embodiments of the present disclosure provide for a prediction of the long-term number of page views that online content will receive. In an embodiment, the article's traffic data is collected for three months, after which a range of traffic, content, and meta features for long-term prediction may be extracted.

Temporal page view patterns of identified evergreen news articles may be examined. For example, using the best setting from 10-fold cross validation, a model was trained on the whole historical dataset from January 2012 to November 2015, and prediction performed on evergreen news articles in each month from December 2015 to December 2016. Page view trajectories from the publication month until March 2018 was viewed. Traffic patterns of top predicted evergreen articles with different feature groups is shown in FIG. 15. As shown in FIG. 15, media predicted with all feature groups exhibit the highest long-term popularity pattern,

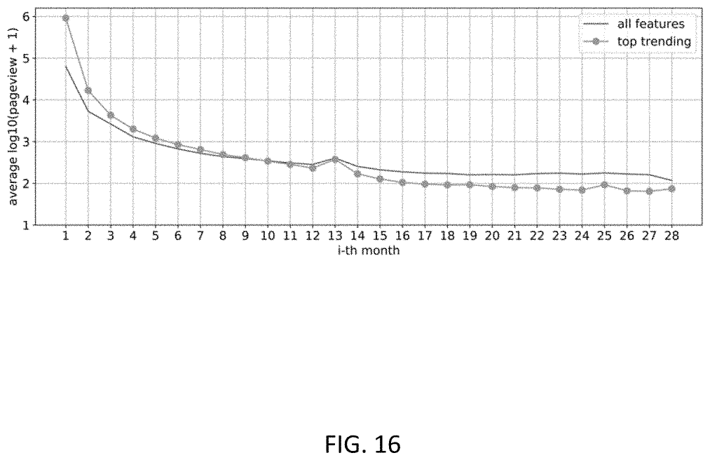

FIG. 16 shows a plot of the page view patterns comparison between top predicted evergreen digital media and top trending digital media in accordance with embodiments of the present disclosure. In FIG. 16, we present page view pattern comparison between top predicted evergreen news articles and top trending news articles. Top trending articles consist of top 100 articles with the highest initial traffics in each month. As expected, top trending articles attract much more traffics in the first few months, while top predicted evergreen articles demonstrate more stable traffic pattern and consistently higher page view numbers one year later.

At this point it should be noted that techniques for predicting the popularity of media in accordance with the present disclosure as described above may involve the processing of input data and the generation of output data to some extent. This input data processing and output data generation may be implemented in hardware or software. For example, specific electronic components may be employed in a server or similar or related circuitry for implementing the functions associated with predicting the popularity of media in accordance with the present disclosure as described above. Alternatively, one or more processors operating in accordance with instructions may implement the functions associated with predicting the popularity of media in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A digital media prediction system comprising a memory storing instructions and a processor configured to execute the instructions, the instructions including:
obtaining digital media from at least one digital media content source;
obtaining user activity data associated with the digital media from at least one client device;
determining at least one characteristic associated with the digital media;
updating a prediction model using the obtained user activity data and the determined at least one characteristic;
determining a long-term popularity track by executing the prediction model;
comparing the long-term popularity track to a predetermined threshold; and
determining that the long-term popularity track exceeds the predetermined threshold;
wherein the long-term popularity track is displayed on a graphical user interface.

2. The digital media prediction system of claim 1, wherein the digital media is a digital article posted on a webpage.

3. The digital media prediction system of claim 1, wherein the user activity comprises the number of views of the digital media.

4. The digital media prediction system of claim 1, wherein the user activity comprises the number of shares of the digital media with other users of a social media platform.

5. The digital media prediction system of claim 1, wherein the user activity is obtained in real-time from the at least one client device.

6. The digital media prediction system of claim 1, wherein the user activity is archived activity that originated from the at least one client device.

7. The digital media prediction system of claim 1, wherein the at least one characteristic is a topic of the digital media.

8. The digital media prediction system of claim 1, wherein the predetermined threshold defines a minimum number of digital media views.

9. The digital media prediction system of claim 1, wherein the prediction model is formed by
$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β ,$$
wherein α defines a minimum guaranteed monthly views of the digital content, β controls a decreasing rate of the digital media views, γ defines a window size, and wherein a first time series associated with the digital media is PV=(pv₁, pv₂, . . . , pvₙ), and a smoothed first time series associated with the digital media is [symbol] =( [symbol] , [symbol] , . . . , [symbol] ).

10. The digital media prediction system of claim 9, wherein γ is equal to 5.

11. The digital media prediction system of claim 9, wherein
$$= median ( [ {pv}_{i - \frac{γ}{2}} , … , {pv}_{i + \frac{γ}{2}} ] )$$

12. A method of predicting digital media popularity, comprising:
obtaining digital media from at least one digital media content source;
analyzing the digital media using a prediction model, wherein the prediction model is formed by
$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β ,$$
wherein α defines a minimum guaranteed monthly views of the digital content, β controls a decreasing rate of the digital media views, γ defines a window size, and wherein a first time series associated with the digital media is PV=(pv, pv₂, . . . , pvₙ), and a smoothed first time series associated with the digital media is [symbol] =( [symbol] , [symbol] , . . . , [symbol] );
determining a long-term popularity track using the analysis of the digital media;
displaying the long-term popularity track on a graphical user interface.

13. The method of claim 12, wherein the digital media is a digital article posted on a webpage.

14. The method of claim 12, further comprising comparing the long-term popularity track to a predetermined threshold, and determining that the long-term popularity track exceeds the predetermined threshold.

15. The method of claim 12, wherein γ is equal to 5.

16. The method of claim 12, wherein
$$= median ( [ {pv}_{i - \frac{γ}{2}} , … , {pv}_{i + \frac{γ}{2}} ] )$$

17. A digital media prediction system comprising a memory storing instructions and a processor configured to execute the instructions, the instructions including:
obtaining digital media from at least one digital media content source;
analyzing the digital media using a prediction model, wherein the prediction model is formed by
$$\frac{1}{n} {\sum }_{i = 1}^{n} \geq α and \frac{1}{n * {\sum }_{i = 1}^{n} } {\sum }_{i = 1}^{n} {\sum }_{j = 1}^{i} \leq β ,$$
wherein α defines a minimum guaranteed monthly views of the digital content, β controls a decreasing rate of the digital media views, γ defines a window size, and wherein a first time series associated with the digital media is PV=(pv₁, pv₂, . . . , pvₙ), and a smoothed first time series associated with the digital media is [symbol] =( [symbol] , [symbol] , . . . , [symbol] );
determining a long-term popularity track using the analysis of the digital media;
displaying the long-term popularity track on a graphical user interface.

18. The method of claim 17, wherein the digital media is a digital article posted on a webpage.

19. The method of claim 17, further comprising comparing the long-term popularity track to a predetermined threshold, and determining that the long-term popularity track exceeds the predetermined threshold.

20. The method of claim 17, wherein γ is equal to 5.
